(19) United States
(12) Patent Application Publication
(10) Pub. No.: US 2012/0286042 A1
(43) Pub. Date: Nov. 15, 2012

(54) CHECKING SYSTEM, CONTROL METHOD FOR CONTROLLING A CHECKING SYSTEM

(75) Inventor: Yasuaki Sawano, Kawasaki-shi (JP)

(73) Assignee: CANON KABUSHIKI KAISHA, Tokyo (JP)

(21) Appl. No.: 13/463,301

(22) Filed: May 3, 2012

(30) Foreign Application Priority Data
May 10, 2011 (JP) 2011-105074

(51) Int. Cl. G06K 5/00

(52) U.S. Cl. 235/437

(57) ABSTRACT

A checking system includes a checking unit that reads a print product printed by a printing unit and checks the print product, and an adding unit that adds a predetermined sheet indicating that the print product is not normal between the print products generated by the printing unit. The checking unit is provided between the printing unit and the adding unit, and the adding unit is configured, according to a result of the check of the print product generated by the printing unit performed by using the checking unit, to add the predetermined sheet indicating that the print product is not normal between the print products generated by the printing unit.

### BACKGROUND OF THE INVENTION

1. Field of the Invention

The present invention relates to a checking system and a control method for controlling a checking system.

2. Description of the Related Art

Systems including a checking apparatus for inspecting a print result of an image printed by a printing apparatus have been known. For example, Japanese Patent Application Laid-Open No. 2004-195680 discusses such a system. The checking apparatus is provided with an image reading apparatus for obtaining an image printed on paper conveyed along a conveyance path as check image data. Based on the check image obtained by the image reading apparatus, the checking apparatus determines whether the print result is good. This enables automatic determination of whether the print result is good. As a result, the user can reprint the image of the print product whose print result is determined to be not normal, and add the reprinted image to the print products that are determined to be normal.

However, in the known systems, when the user reprints the image of the print product that is determined to be not normal after the determination, it is difficult to determine to which part of the print products that are determined to be normal, the reprinted print product is to be added. For example, Japanese Patent Application Laid-Open No. 2004-195680 discusses a technique in which the user is only notified that the print result is not normal when it is determined that the print result is not normal as a result of the check, and fails to facilitate the determination to which part of the print products that are determined to be normal the reprinted print product is to be added.

### SUMMARY OF THE INVENTION

According to an aspect of the present invention, a checking system is provided. The checking system includes a checking unit that reads a print product printed by a printing unit and checks the print product, and an adding unit that adds a predetermined sheet indicating that the print product is not normal between the print products generated by the printing unit. The checking unit is provided between the printing unit and the adding unit, and the adding unit is configured, according to a result of the check of the print product generated by the printing unit performed by using the checking unit, to add the predetermined sheet indicating that the print product is not normal between the print products generated by the printing unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a printing system according to an exemplary embodiment.

FIG. 2 is a flowchart illustrating a checking processing method in the printing system.

FIG. 3 illustrates an example of a checking setting screen displayed on a display unit in an operation unit in a checking apparatus.

FIG. 4 is a flowchart illustrating a checking processing method in the printing system.

FIG. 5 illustrates a configuration of the printing system according to the exemplary embodiment.

### DESCRIPTION OF THE EMBODIMENTS

Various exemplary embodiments, features, and aspects of the invention will be described in detail below with reference to the drawings.

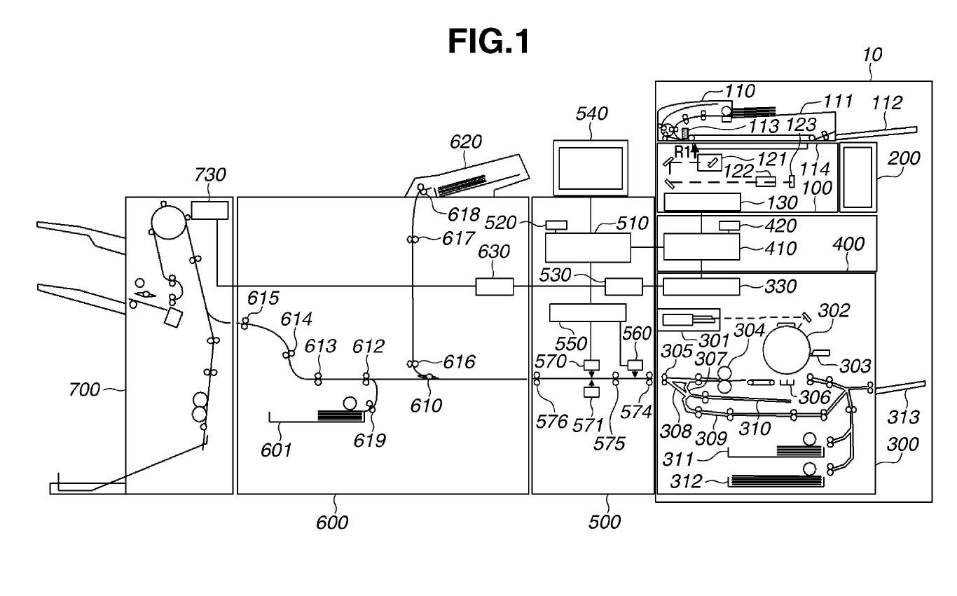

A first exemplary embodiment is described. FIG. 1 illustrates a configuration of a printing system according to the present exemplary embodiment. The printing system includes an image forming apparatus 10, a checking apparatus 500, an inserter 600, and a finisher 700. The image forming apparatus 10 includes a scanner unit 100 and a printer unit 300. The scanner unit 100 reads an image on a document, and generates image data corresponding to the read image. The printer unit 300 prints the image read by the scanner unit 100 on paper. In the exemplary embodiment, as an example of the image forming apparatus 10, a multifunction peripheral (MFP) having a plurality of functions such as a copying function and a page description language (PDL) print function is employed. Alternatively, the image forming apparatus 10 may be a single function printer (SFP) having a single function.

The checking apparatus 500 checks a print product printed in the image forming apparatus 10 and conveyed. The inserter 600 can insert specific paper between papers conveyed from the checking apparatus 500. The finisher 700 discharges the print product conveyed from the inserter 600 onto a discharge tray, and executes stapling processing to the print product or saddle stitch bookbinding processing as necessary. The image forming apparatus 10, the checking apparatus 500, the inserter 600, and the finisher 700 are detachably attached to each other. The user can change the order of the apparatuses in a desired order. In the present exemplary embodiment, in the printing system, the apparatuses are connected in the order of the checking apparatus 500, the inserter 600, and the finisher 700 from the apparatus closer to the image forming apparatus 10. In the description, it is defined that the side of the image forming apparatus 10 is the upstream side, and the side of the finisher 700 is the downstream side. In other words, the checking apparatus 500 is provided at the downstream side with reference to the image forming apparatus 10, and the inserter 600 is provided at the downstream side with reference to the checking apparatus 500.

As illustrated in FIG. 1, the image forming apparatus 10, the checking apparatus 500, the inserter 600, and the finisher 700 can be connected with each other via control lines. The control lines of the individual apparatuses can be coupled with each other when the apparatuses are connected to each other. The individual apparatuses include a control unit having a central processing unit (CPU), a read-only memory (ROM), a random access memory (RAM), and the like. The control units in the individual apparatuses can transmit or receive a command or data via the control lines.

The checking apparatus 500 includes a device control unit 530. The device control unit 530 obtains image data of a document read by the image forming apparatus 10, compares the obtained image data and image data of paper read by optical units 570 and 571, and checks a state of the image on the print product. The device control unit 530 notifies the inserter 600 of a check result.

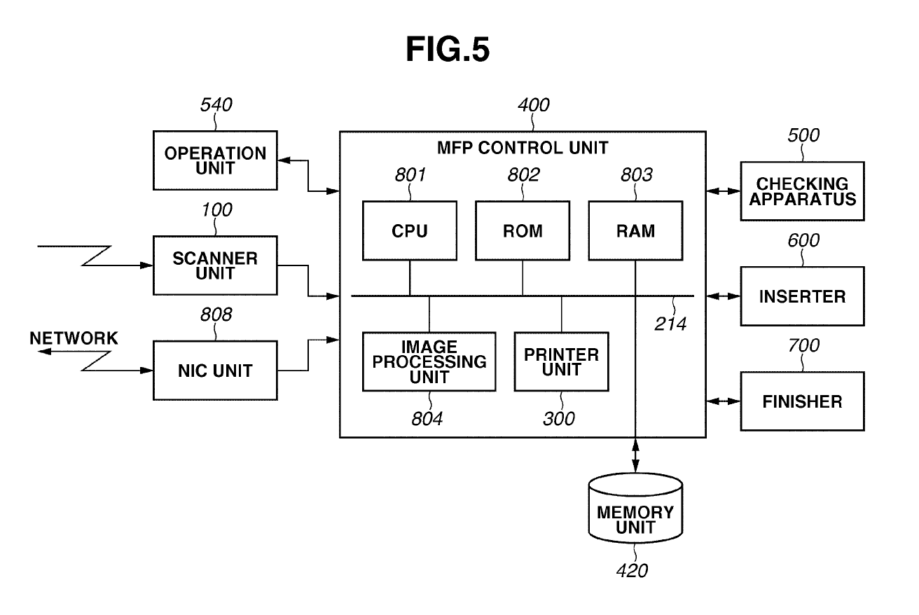

FIG. 5 is a block diagram illustrating a configuration of the printing system. A CPU 801 performs overall control of the printing system by reading a program stored in a ROM 802 to a RAM 803, and executing the program. The ROM 802 stores various types of programs read by the CPU 801. The RAM 803 serves as a work area of the CPU 801.

An image processing unit 804 performs color space conversion or resolution conversion of image data according to instructions from the CPU 801. The printer unit 300 forms an image on paper supplied from a paper feeding apparatus 809. The paper on which the image is formed is conveyed to an apparatus at the downstream side with respect to the image forming apparatus 10.

A memory unit 420 is, for example, a hard disk drive (HDD) for storing image data and a program. An MFP control unit 400 can transmit or receive a signal to or from an operation unit 540, a scanner unit 100, a network interface card (NIC) unit 808, the paper feeding apparatus 809, the checking apparatus 500, the inserter 600, and the finisher 700. The MFP control unit 400 controls the individual apparatuses by transmitting or receiving data between the individual apparatuses.

The MFP control unit 400 stores the image data received from the scanner unit 100 in a memory unit 420, and performs printing according to the stored image data using the printer unit 300. Further, the MFP control unit 400 analyzes print data received via the NIC unit 808, and executes printing according to the analyzed print data using the printer unit 300. In the printing system according to the exemplary embodiment, the inserter 600 is connected at the downstream side with respect to the checking apparatus 500. As a result, insertion paper indicating that the print result checked by the checking apparatus 500 is determined to be not normal can be inserted without stopping the printing processing. The control method is specifically described.

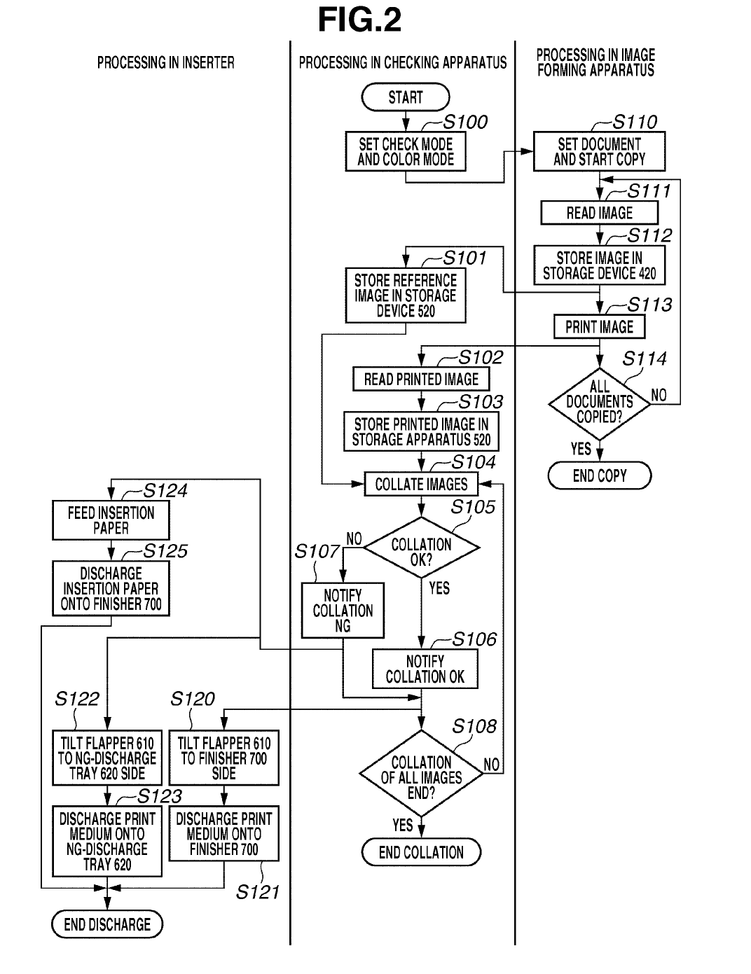

FIG. 2 is a flowchart illustrating a checking processing method in the printing system according to the present exemplary embodiment. The present example is implemented by CPUs, which are provided in the MFP control unit 400 and the device control units 530 and 630 and load a control program stored in the ROMs or the like in the RAMs and execute the program.

Hereinafter, a checking processing flow performed in copy job processing of copying two-sided document in the image forming apparatus 10, and inspecting the print result by the checking apparatus 500 is described. The job processing to which the exemplary embodiment of the present invention can be applied includes the copy job processing. Further, similar checking processing can be performed in a print job processing received from an external device.

In the printing system according to the exemplary embodiment, an insertion paper cassette 601 in the inserter 600 is provided in the vicinity of the sheet discharge conveyance path at the downstream side with respect to the checking apparatus 500. Consequently, it can be controlled such that a sheet whose print result is determined to be not normal (NG) in sheet checking processing described below is discharged onto an NG paper discharge tray 620 and insertion paper is inserted into the place corresponding to the sheet from the insertion paper cassette 601. Specifically, the device control unit 630 in the inserter 600 controls the insertion processing of the insertion paper at a timing described below.

Specifically, the device control unit 630 performs paper discharge control of changing the discharge destination of the paper whose print result is determined to be not normal from a normal discharge destination to an evacuation destination by switching a flapper 610. The device control unit 630 performs control of inserting the insertion paper stored in the insertion paper cassette 601 according to timing of conveying the paper whose discharge destination is switched to the evacuation destination according to the flowchart illustrated in FIG. 2. In step S100, the checking apparatus 500 receives settings of the checking processing from the user via the operation unit 540.

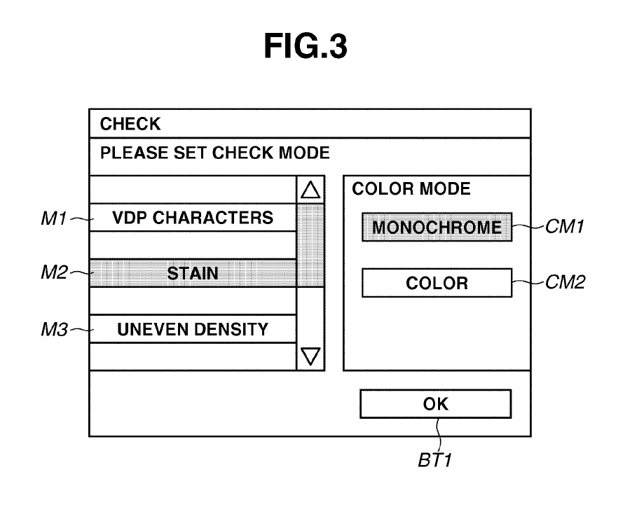

FIG. 3 illustrates an example of a check setting screen displayed on a display unit in the operation unit 540 in the checking apparatus 500 illustrated in FIG. 1. In FIG. 3, on the screen, the check modes and the color modes are displayed. The selected modes (the stain mode and the monochrome mode) are highlighted. The check modes according to the exemplary embodiment are described.

In the present exemplary embodiment, the check modes include three modes; the VDP character mode, the stain (spots, scatterings, etc.) mode, and the uneven density mode. However, the check modes can include other modes.

In the name “VDP character mode M1”, “VDP” is an abbreviation of “variable data publishing”. The VDP is personalized publishing in which print products of different targets can be obtained.

For example, the VDP can be applied to printing of direct mails including data having different contents such as zip codes and addresses. The VDP character mode is used to check whether the print contents are printed as intended.

The stain mode M2 is used to check whether a print product includes an unintended image such as a spot or a scattering of toner, a white spot, or an unexpected line.

The uneven density mode M3 is used to check whether parts having the same density in a print product are output in the same density. Normally, the setting of the VDP character mode is valid in print jobs, and the settings of the stain mode and the uneven density mode are valid in both copy jobs and print jobs.

The color mode includes two types of modes: the monochrome mode CM1, and the color mode CM2. In the monochrome mode CM1, data is read as a grayscale 8 bits image. In the color mode CM2, data is read as 8 bits images for each RGB color.

When the user presses the OK button to define the setting for the check mode using the setting screen, a document conveyance apparatus 110 detects two-sided documents set by the user on a document tray 111. In step S110, an operation unit 200 detects that a copy start button (not illustrated) in the operation unit 200 is pressed by the user, and instructs the MFP control unit 400 to start copying processing.

When the MFP control unit 400 detects the copy start instruction by the user, the MFP control unit 400 instructs a read control apparatus 130 to start scanning processing. The read control apparatus 130 instructs the document conveyance apparatus 110 to convey the documents set on the document tray 111 one by one from the top page. The document conveyance apparatus 110 conveys the documents onto a document positioning glass 114 via a curved path. In the present exemplary embodiment, the copying processing of the two-sided documents is performed, and consequently, in step S111, data of the front surface is read using a scanner unit 121, and the rear surface is read using an optical unit 113 arranged in the document conveyance apparatus 110. In the optical unit 113, an image sensor, a light source, and the like (not illustrated) are arranged. In step S112, image processing is performed to an image of the document read by an image sensor 123 through a lens 122 in an image processing apparatus 410. The image is transmitted to an exposure control unit 301 via a printer control unit 330 while the image is stored in the memory unit 420. In step S101, the document image data stored in the memory unit 420 is transmitted to a storage apparatus 520 in the checking apparatus 500 as a reference image.

The exposure control unit 301 outputs a laser beam corresponding to the image signal. When the photosensitive drum 302 is irradiated with the laser beam, an electrostatic latent image is formed on the photosensitive drum 302. The electrostatic latent image on the photosensitive drum 302 is developed by a developing unit 303. The developer on the photosensitive drum 302 is transferred by a transfer unit 306 onto a print medium supplied from one of cassettes 311 and 312, or a manual paper feeding unit 313. In step S113, the sheet onto which the developer is transferred is guided to a fixing unit 304, and developer fixing processing is performed.

The print medium that passed through the fixing unit 304 is once guided from a path 307 to a path 310 using a flapper (not illustrated). After the trailing edge of the sheet passes through the path 307, the print medium is switched back and guided from a path 308 to a discharge roller 305.

According to the above processing, the sheet can be discharged from the printer unit 300 by the discharge roller 305 in a state the surface onto which the developer is transferred faces downward (facedown). This processing is called a reversed paper discharge processing. The facedown discharge enables the apparatus to perform image formation in the correct page order starting from the top page, for example, when the user instructs printing of images formed by reading a plurality of documents using the document conveyance apparatus 110.

If image formation processing is performed on a hard sheet such as an OHP sheet from the manual paper feeding unit 313, the sheet is discharged from the discharge roller 305 while the surface onto which the developer is transferred faces upward (faceup) without being guided to the path 307.

If image formation processing is performed on both sides of a print medium such as plain paper, the print medium is guided from the fixing unit 304 to the paths 307 and 310. Further, right after the trailing edge of the print medium passes through the path 307, the print medium is switched back, and guided to a two-sided conveyance path 309 using a flapper (not illustrated).

Onto the print medium guided to the two-sided conveyance path 309, an electrostatic latent image is transferred in the transfer unit 306 again, and fixing processing is performed in the fixing unit 304. In this way, the path lengths, the roller arrangements, and the division of the driving systems are made such that, for example, the print medium can be conveyed even when five sheets of half-size paper such as the A4 size, the B5 size exist in the circular path from the transfer unit 306 via the two-sided conveyance path 309 to the transfer unit 306 again. In the processing, the odd pages are discharged to face downward. Consequently, the discharge page order can be adjusted to a page order in the two-sided copying processing.

The print medium printed in the image forming apparatus 10 is conveyed to the checking apparatus 500. The checking apparatus 500 includes a detection sensor 560 provided above the conveyance path of the print medium. In step S102, when the detection sensor 560 detects the print medium on the conveyance path, the read control apparatus 550 reads the print medium as a print image using the optical units 570 and 571. In step S103, the read print image is stored in the storage apparatus 520.

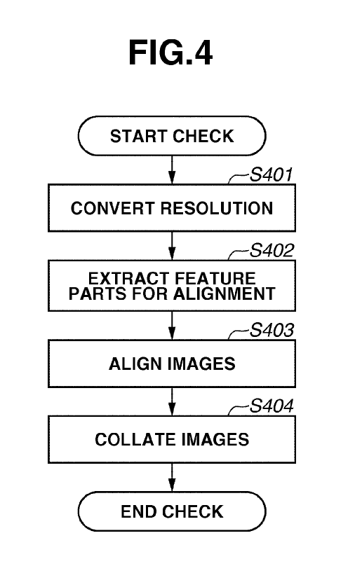

In step S104, the checking apparatus 500 collates the image obtained in step S101 with the image obtained in step S103. An example of the image collation method is described with reference to FIG. 4 below.

As a result of the image collation, if the collation is OK, that is, the image has no stain (YES in step S105), in step S106, the checking apparatus 500 notifies the device control unit 630 in the inserter 600 of the notification of collation OK from the device control unit 530 in the checking apparatus 500. In step S120, the device control unit 630 in the inserter 600 tilts upward the tip of a flapper 610 of the inserter 600. Consequently, in step S121, the print medium discharged from the checking apparatus 500 passes through the flapper 610, rollers 612, 613, 614, and 615 in the inserter 600, and the print medium is discharged to the finisher 700.

As a result of the image collation, if the collation is NG, that is, the image has a stain (NO in step S105), in step S107, the checking apparatus 500 notifies the device control unit 630 in the inserter 600 of the notification of collation NG from the device control unit 530 in the checking apparatus 500. In step S122, the device control unit 630 in the inserter 600 tilts downward the tip of the flapper 610 of the inserter 600. Consequently, in step S123, the print medium discharged from the checking apparatus 500 passes through the flapper 610, rollers 616, 617, and 618 in the inserter 600, and the print medium is discharged onto the NG discharge tray 620. In step S124, the device control unit 630 in the inserter 600 operates paper feeding rollers 619 and feeds insertion paper from the insertion paper cassette 601. In step S125, the insertion paper passes through paper feeding rollers 619, the rollers 612, 613, 614, and 615 in the inserter 600, and the insertion paper is discharged to the finisher 700.

The device control unit 630 determines the timing for feeding the insertion paper when the image collation result is NG using the distance between the flapper 610 and the rollers 612, the conveyance speed of the print medium, and the like. According to the above processing, the index paper can be inserted into the NG portion in the print products (sheets) without stopping the conveyance processing of the sheets output from the printer unit 300.

The above-described check flow is applied to data of one page. In a case of data of a plurality of pages, similar processing is repeated for the pages. In other words, in the image forming apparatus 10, after the image is printed in step S113, in step S114, the MFP control unit 410 determines whether the copying processing is performed on all documents. If the processing is not finished (NO in step S114), the processing returns to the image reading processing in step S111. In the checking apparatus 500, in step S108, the image processing unit 510 determines whether the collation processing is performed on all images. If the processing is not finished (NO in step S108), the processing returns to the image collation processing in step S104.

In the exemplary embodiment, the flow of simultaneously printing and inspecting an image while reading a document is described. Alternatively, for example, the reading processing of all documents may be finished first, and the images may be printed and checked. The checking processing can be similarly applied to print jobs. In the print job, to the MFP control unit 400 in the image forming apparatus 10 in FIG. 1, the print job is input, and a reference image is to be formed.

Further, depending on a position where a jam occurred, whether to continue or stop the printing processing can be controlled. For example, when a jam occurs in the rollers 616 to 618 in the inserter 600, the jam does not affect the operation performed when the image collation result is OK. Consequently, the processing is continued with only warning display on the operation unit 200 in the image forming apparatus 10. The operation rate of the image forming apparatus 10 can be further increased by stopping the printing processing only after the jam starts to affect the operation when the image collation result is OK.

An example of the image collation processing in step S104 in the copy check flowchart in FIG. 2 is described with reference to the flowchart in FIG. 4. The processing illustrated in the flowchart is implemented by the CPU, which is provided in the device control unit 530 and load a control program stored in the ROM or the like into the RAM and execute the program.

In step S401, the device control unit 530 converts the resolution of the reference image obtained in step S101 using the image processing unit 510. Normally, the reference image is a 600 dpi image or a 1200 dpi image. However, the image collation processing is performed at 300 dpi or 150 dpi, and consequently, processing for converting the resolutions is performed.

In step S402, the device control unit 530 extracts a feature part in the reference image to align the images using the image processing unit 510.

The resolution for reading the image on the sheet using the optical units 570 and 571 in step S102 is set to the resolution of the resolution-converted reference image in step S401. According to the above processing, the resolution conversion for the read print image can be eliminated, and consequently, it is useful to perform the processing.

In step S403, the device control unit 530 extracts a part similar to the feature part in the reference image extracted in step S402 from the image data read in step S102. The device control unit 530 calculates a shift amount, a rate of enlargement or reduction, and a rotational angle using the image processing unit 510, and performs alignment processing.

In step S404, the device control unit 530 performs the image collation processing of the resolution-converted reference image data and the image data read in step S102 using the image processing unit 510, and detects whether the print result is normal.

As a result of the image collation, if the image processing unit 510 determines that the difference amount of the two pieces of the image data is small, the image processing unit 510 determines that the image data on the sheet is normally printed. On the other hand, if the image processing unit 510 determines that the difference amount is large, the image processing unit 510 determines that the image data on the sheet contains a stain.

Alternatively to the above-described image collation processing, various kinds of processing methods can be employed. When the reference image is received from an external device, in step S402 and step S403, in order to adjust the color space of the print image to the color space of the read image, it is useful to perform color space conversion (luminance to density) of the reference image in the image processing unit 510. According to the above processing, the collation of the reference image and the image read in step S102 can be properly performed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-105074 filed May 10, 2011, which is hereby incorporated by reference herein in its entirety.

What is claimed is:

1. A checking system comprising:
a checking unit configured to read a print product printed by a printing unit and check the print product; and
an adding unit configured to add a predetermined sheet indicating that the print product is not normal between the print products generated by the printing unit,
wherein the checking unit is provided between the printing unit and the adding unit, and the adding unit is configured, according to a result of the check of the print product generated by the printing unit performed by using the checking unit, to add the predetermined sheet indicating that the print product is not normal between the print products generated by the printing unit.

2. The checking system according to claim 1, wherein the checking unit comprises an obtaining unit configured to obtain image data from the printing unit, and
wherein the checking unit is configured to read an image printed on the print product and check the read image by comparing the image data generated based on the read image to the image data obtained by the obtaining unit.

3. The checking system according to claim 1, wherein the checking unit is provided between the printing unit and the adding unit, and

4. The checking system according to claim 1, further comprising a reading unit configured to read an image on a document and generate image data,
wherein the printing unit is configured to print the image according to the image data generated by the reading unit.

5. The checking system according to claim 1, further comprising a receiving unit configured to receive image data from an external device,
wherein the printing unit is configured to print the image according to the image data received by the receiving unit.

6. The checking system according to claim 1, wherein the checking system includes the printing unit, and
wherein the printing unit is configured to generate a print product by printing an image on a sheet according to image data.

7. A control method for controlling a checking system, the checking system comprising a checking unit configured to read a print product printed by a printing unit and check the print product, and an adding unit configured to add a predetermined sheet indicating that the print product is not normal between the print products generated by the printing unit, the checking unit being provided between the printing unit and the adding unit, the control method comprises:
checking, by the checking unit, the print product generated by the printing unit; and
adding, by the adding unit, according to a result of the check of the print product, the predetermined sheet indicating that the print product is not normal between the print products generated by the printing unit
